(19) United States
(12) Patent Application Publication
(10) Pub. No.: US 2009/0323125 A1
(43) Pub. Date: Dec. 31, 2009

(54) IMAGE GENERATING APPARATUS

(75) Inventor: Haruko Kawakami, Mishima-shi (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Minato-ku (JP); TOSHIBA TEC KABUSHIKI KAISHA, Shinagawa-ku (JP)

(21) Appl. No.: 12/490,769

(22) Filed: Jun. 24, 2009

Related U.S. Application Data
(60) Provisional application No. 61/076,281, filed on Jun. 27, 2008.
(60) Provisional application No. 61/076,280, filed on Jun. 27, 2008.

(51) Int. Cl. H04N 1/40

(52) U.S. Cl. 358/3.28

(57) ABSTRACT

An image generating apparatus is provided which includes: a modulating section which, by using different additional images corresponding to different pattern images, modulates signals of the pattern images to generate plural modulated pattern images; and a superimposing section which, by changing color information of a color image in accordance with each of the modulated pattern images, superimposes the plural modulated pattern images on the color image to generate a recordable combined image.

### CROSS-REFERENCE TO RELATED APPLICATION

This application is based upon and claims the benefit of priority from: U.S. provisional application 61/076,280, filed on Jun. 27, 2008; and U.S. provisional application 61/076,281, filed on Jun. 27, 2008, the entire contents of each of which are incorporated herein by reference.

### TECHNICAL FIELD

The present invention relates to an image generating apparatus which superimposes plural additional images on a color image to generate a combined image.

### BACKGROUND

The widespread use of copy machines enables easy duplication of images (original). Thus, a method for confirming whether an image is authentic (original) or not is required.

In JP-A-2004-48800, a single first image is embedded in a second image (original) to generate a combined image. If the combined image is observed with the naked eye, only the second image is visually recognized. Meanwhile, if a special sheet is superimposed on a recording object in which the combined image is recorded, the first image is seen as overlapping the second image. This enables confirmation as to whether the original image is counterfeited or not.

However, in confirming the counterfeit, it may be insufficient simply to embed the single first image in the second image.

### SUMMARY

To solve the foregoing problem, according to an aspect of the invention, an image generating apparatus includes: a modulating section which, by using different additional images corresponding to different pattern images, modulates signals of the pattern images to generate plural modulated pattern images; and a superimposing section which, by changing color information of a color image in accordance with each of the modulated pattern images, superimposes the plural modulated pattern images on the color image to generate a recordable combined image.

According to another aspect of the invention, an image generating method includes: by using different additional images corresponding to different pattern images, modulating signals of the pattern images to generate plural modulated pattern images; and by changing color information of a color image in accordance with each of the modulated pattern images, superimposing the plural modulated pattern images on the color image to generate a recordable combined image.

### DESCRIPTION OF THE DRAWINGS

FIG. 1 is a block diagram showing the configuration of an image generating apparatus according to a first embodiment of the invention.

FIG. 2 is a schematic view showing a basic pattern stored in a memory.

FIG. 3 illustrates a method for generating an embedding pattern.

FIG. 4 illustrates another method for generating an embedding pattern.

FIG. 5 is a flowchart showing a method for generating a combined image.

FIG. 6A shows a pattern formed on a mask sheet.

FIG. 6B shows another pattern formed on a mask sheet.

FIG. 7 is a flowchart showing processing to form a pattern on a mask sheet.

FIG. 8A is a schematic view showing pixels that are highlighted when a mask sheet is superimposed on a combined image.

FIG. 8B is a schematic view showing the display state when a mask sheet is superimposed on a combined image.

FIG. 9A is a schematic view showing pixels that are highlighted when another mask sheet is superimposed on a combined image.

FIG. 9B is a schematic view showing the display state when another mask sheet is superimposed on a combined image.

FIG. 10 illustrates a method for generating an embedding pattern in a second embodiment of the invention.

FIG. 11 shows a superimposing area of an embedding pattern in a color image in a third embodiment of the invention.

FIG. 12 is a block diagram showing the configuration of an image generating apparatus according to a fourth embodiment of the invention.

FIG. 13 shows a bit layout on a Fourier transform plane.

FIG. 14 shows a bit layout on a Fourier transform plane.

### DETAILED DESCRIPTION

Hereinafter, embodiments of the invention will be described with reference to the drawings.

### First Embodiment

An image generating apparatus according to a first embodiment of the invention will be described. The image generating apparatus according to this embodiment embeds plural embedding images (additional images) in a color image and thus generates a combined image. The plural embedding images are different from each other. The generated combined image is recorded (formed) on a recording object such as a sheet.

If the combined image recorded on the recording object is directly observed by a person from outside, almost only the color image is visually recognized and the embedding image is not visually recognized. On the other hand, if a special sheet is used which will be described later, the embedding image in the combined image (color image) can be visually recognized.

FIG. 1 shows the configuration of the image generating apparatus according to the embodiment.

Data of a color image S1 as an original is inputted to an input section 101. The data of the color image S1 is sent to a superimposing section 102.

Meanwhile, data of n embedding images 103-1 to 103-n embedded in the color image S1 are sent to an embedding pattern generating section 104. The number n is an integer equal to or greater than 2. The number n and content of the embedding images embedded in the color image S1 can be properly selected by a user.

The embedding images 103-1 to 103-n show different contents from each other. The contents in this case refer to features that enable each image to be identified by external observation, for example, the size and shape of the image. The images also include pictures, letters, symbols, and numerals.

The data of the embedding images 103-1 to 103-n can be prepared and stored in advance in a memory (not shown). Embedding image data may also be newly prepared and added to the memory.

The embedding pattern generating section (modulating section) 104 acquires basic patterns (pattern images) from a memory 105. Also, newly prepared embedding image data can be supplied to the embedding pattern generating section 104.

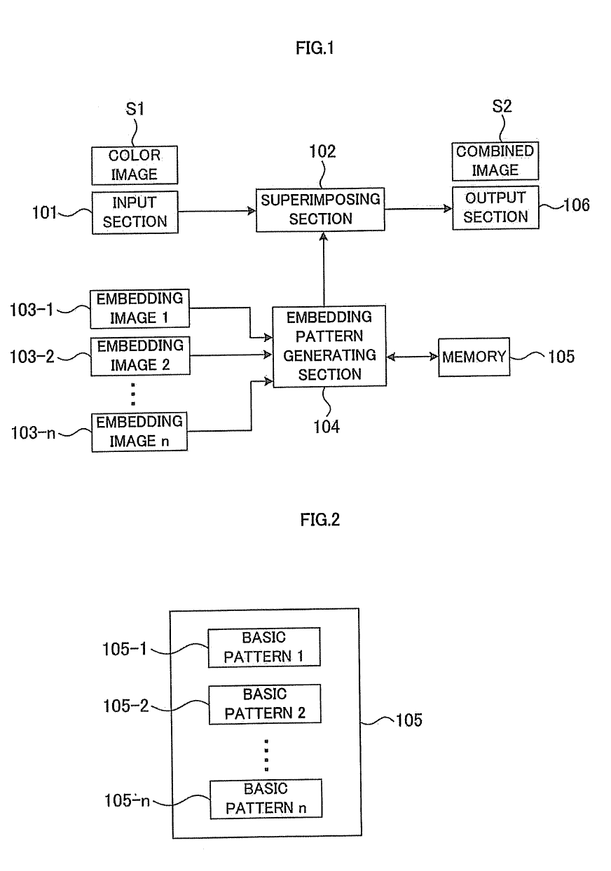

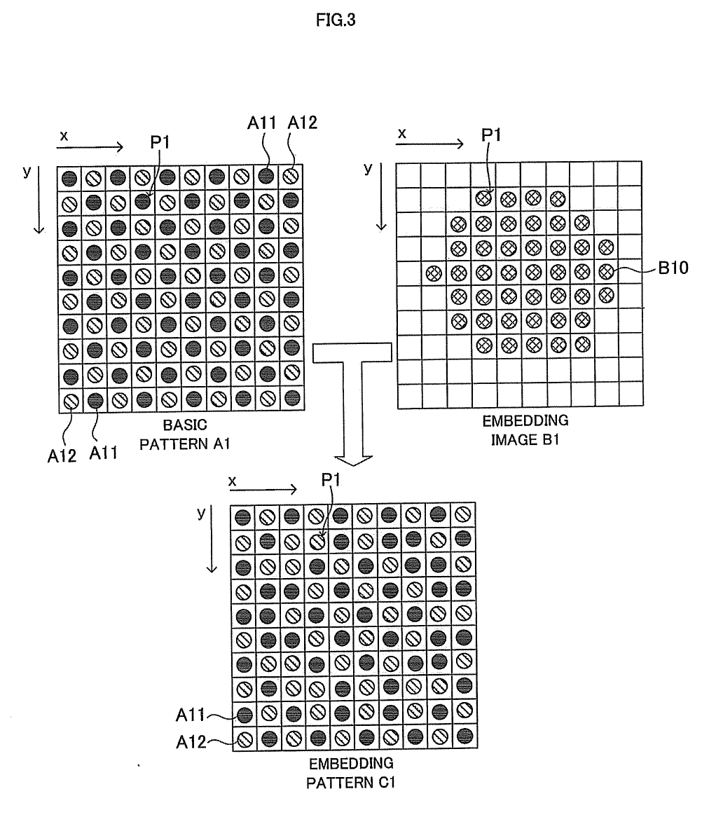

FIG. 2 shows plural basic patterns 105-1 to 105-n stored in the memory 105. The basic patterns 105-1 to 105-n have different patterns from each other. It is preferable that the basic patterns 105-1 to 105-n have a high spatial frequency that is not easily perceptible to the human eye.

The basic patterns 105-1 to 105-n are prepared in the number equal to the number of the data of the embedding images 103-1 to 103-n. The basic patterns 105-1 to 105-n correspond to the embedding image data 103-1 to 103-n.

If specific embedding image data 103-k (where k is an arbitrary value from 1 to n) is inputted, the embedding pattern generating section 104 reads out the basic pattern 105-k corresponding to the embedding image data 103-k from the memory 105. The embedding pattern generating section 104 processes the corresponding basic pattern 105-k on the basis of the embedding image data 103-k and thus generates an embedding pattern (modulated pattern image).

Specifically, the embedding pattern generating section 104 modulates the signal of the basic pattern 105-k with the signal of the embedding image data 103-k and thereby generates the signal of the embedding pattern. The embedding pattern generating section 104 supplies the generated embedding pattern to the superimposing section 102.

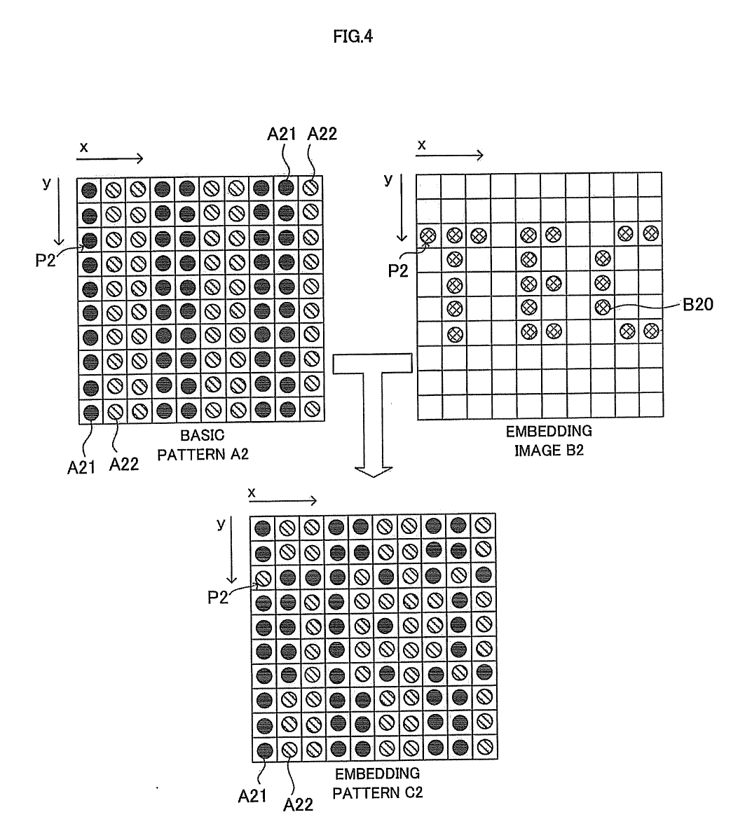

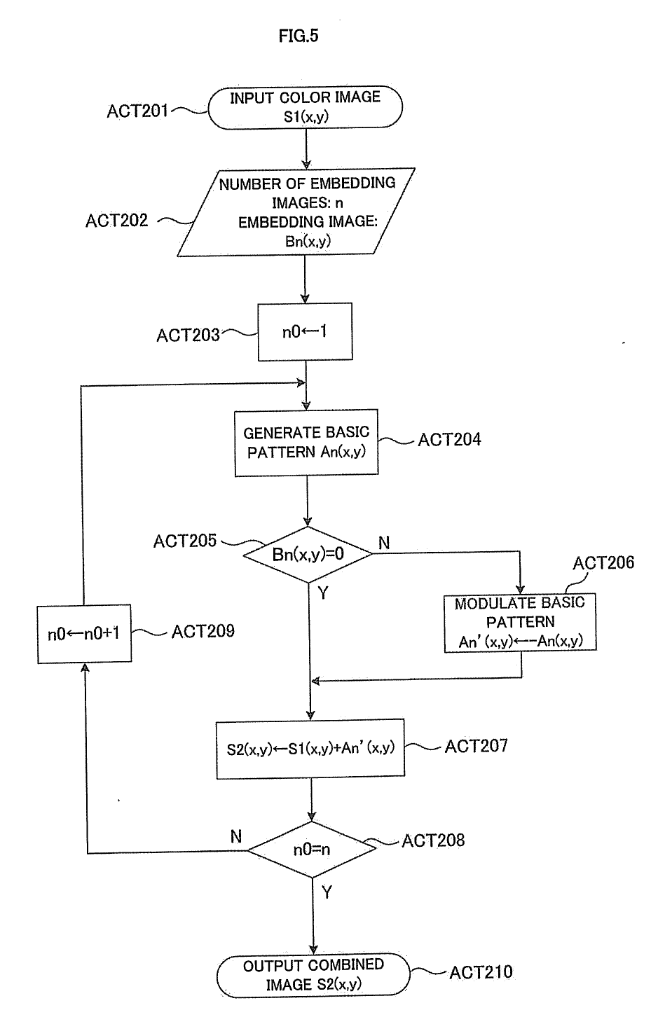

A method for generating an embedding pattern will be described specifically with reference to FIG. 3 and FIG. 4.

An embedding pattern C1 shown in FIG. 3 is a pattern acquired by processing (modulating) a basic pattern A1 with an embedding image B1.

The basic pattern A1 includes plural pixels A11 and A12 that are different from each other. The pixels A11 and A12 serve as indexes for changing the color difference of the color image S1, as will be described later. In the pixels A11 and A12, values used for changing the color difference are different from each other. In the basic pattern A1, the pixels A11 and A12 are arranged alternately in the x-direction and the y-direction.

The embedding image B1 is a monochrome binary image to be embedded in the color image S1. The embedding image B1 has an image area including plural pixels B10 and a background area where no pixels B10 are located. The basic pattern A1 and the embedding image B1 have the same size (the same number of pixels).

The embedding pattern C1 is generated by inverting pixels in the basic pattern A1 corresponding to the pixels B10 in the embedding image B1. For example, in the embedding image Bi, the pixel B10 exists at a position P1 ((x,y)=(4,2)). Therefore, the pixel at the position P1 in the basic pattern A1 is changed from a pixel A11 to a pixel A12.

An embedding pattern C2 shown in FIG. 4 is a pattern acquired by processing (modulating) a basic pattern A2 with an embedding image B2.

The basic pattern A2 has a different pattern from the basic pattern A1 shown in FIG. 3. In the basic pattern A2, plural pixels A21 are arrayed in the y-direction, and in some areas, lines of pixels A21 are arrayed in the x-direction. Moreover, plural pixels A22 are arrayed in the y-direction, and in some areas, lines of pixels A22 are arrayed in the x-direction. The pixels A21 and A22 have the function similar to that of the pixels A11 and A12 described with reference to FIG. 3.

The content of the embedding image B2 is different from the content of the embedding image B1 shown in FIG. 3. The embedding image B2 has an image area including plural pixels B20 and a background area where no pixels B20 are located. In the embedding image B2, letters “TEC” are formed by plural pixels B20. The basic pattern A2 and the embedding pattern C2 have the same size (the same number of pixels).

The embedding pattern C2 is generated by inverting pixels in the basic pattern A2 corresponding to the pixels B20 in the embedding image B2. For example, in the embedding image B2, the pixel B20 exists at a position P2 ((x,y)=(1,3)). Therefore, the pixel at the position P2 in the basic pattern A2 is changed from a pixel A21 to a pixel A22.

In the descriptions with reference to FIG. 3 and FIG. 4, the pixels in the basic patterns A1 and A2 that overlap the pixels B10 and B20 in the embedding images B1 and B2 are inverted. However, pixel inversion is not limited to this. For example, pixels in the areas in the basic patterns A1 and A2 that overlap the background areas in the embedding images B1 and B2 can be inverted. In this case, the pixels in the basic patterns A1 and A2 overlapping the pixels B10 and B20 are not inverted.

The superimposing section 102 shown in FIG. 1 superimposes the plural embedding patterns supplied from the embedding pattern generating section 104 on the color image S1 supplied from the input section 101 and thereby generates a combined image.

Specifically, the superimposing section 102 changes the color difference of the color image S1 in accordance with each embedding pattern. By changing the color difference, it is possible to make a change in the color image S1 that cannot easily be observed with the naked eye. Saturation can be changed instead of color difference. Alternatively, both color difference and saturation can be changed.

A method for superimposing the embedding pattern C1 shown in FIG. 3 and the embedding pattern C2 shown in FIG. 4 on the color image S1 will now be described.

In the case of superimposing the embedding pattern C1 shown in FIG. 3 on the color image S1, modulation in the yellow-blue direction that cannot easily be recognized by the human sense of sight can be performed on the color image S1 on the basis of the embedding pattern C1. For example, for the pixels in the color image S1 corresponding to the pixels A11 in the embedding pattern C1, the pixel values can be changed as expressed by the following equations (1) to (3).

R₂=R₁+d/6 (1)

G₂=G₁₊d/6 (2)

B₂=B₁−d/3 (3)

R₁, G₁ and B₁ indicate the value of each color component in the color image S1 supplied from the input section 101. R₂, G₂ and B₂ indicate the value of each color component after the color image S1 is modulated with the embedding pattern C1. The symbol d indicates the fluctuation range.

Meanwhile, for the pixels in the color image S1 corresponding to the pixels A12 in the embedding pattern C1, the pixel values can be changed as expressed by the following equations (4) to (6). In equations (4) to (6), the sign of “(d)” in equations (1) to (3) is inverted.

R₂=R₁−d/6 (4)

G₂=G₁−d/6 (5)

B₂=B₁+d/3 (6)

With the above modulation, the embedding pattern C1 shown in FIG. 3 can be superimposed on the color image S1.

Here, the size of the embedding pattern C1 may be coincident with the size of the color image S1 or may be smaller than the size of the color image S1. If the embedding pattern C1 and the color image S1 have the same size, the embedding pattern is superimposed on the entire color image S1. If the embedding pattern C1 is smaller than the color image S1, the embedding pattern C1 is superimposed on a predetermined area in the color image S1. In this case, the position where the embedding pattern C1 is superimposed can be suitably set.

Next, the superimposing section 102 superimposes the embedding pattern C2 shown in FIG. 4 on the color image S1 on which the embedding pattern C1 is superimposed. The method for superimposing the embedding pattern C2 is similar to the foregoing method for superimposing the embedding pattern C1. The embedding pattern C2 is superimposed on the same area as the embedding pattern C1.

For example, for the pixels in the color image S1 corresponding to the pixels A21 in the embedding pattern C2, the pixel values can be changed similarly to the equations (1) to (3). For the pixels in the color image S1 corresponding to the pixels A22 in the embedding pattern C2, the pixel values can be changed similarly to the equations (4) to (6).

Thus, an image (a combined image S2; see FIG. 1) including the two embedding images B1 and B2 embedded in the color image S1 is provided.

Here, since the embedding patterns C1 and C2 are superimposed on the same area in the color image S1, the interference by the embedding patterns C1 and C2 may make the embedding images B1 and B2 difficult to visually recognize even if the an image reproducing method which will be described later is used. Thus, in order to reduce the interference by the embedding patterns C1 and C2, modulation can be carried out in different color difference directions from each other.

For example, at the time of superimposing the embedding pattern C1 on the color image S1, modulation is carried out in the yellow-blue direction. At the time of superimposing the embedding pattern C2, modulation can be carried out in the magenta-green direction.

More specifically, at the time of superimposing the embedding pattern C1, the color image S1 can be modulated by using the equations (1) to (6). Meanwhile, at the time of superimposing the embedding pattern C2, the pixel values of the pixels corresponding to the pixels A21 can be changed as expressed by the following equations (7) to (9).

R₂=R₁−d/6 (7)

G₂=G₁+d/3 (8)

B₂=B₁−d/6 (9)

For the pixels corresponding to the pixels A22 in the embedding pattern C2, the pixel values can be changed by using the equations (7) to (9) with the sign of “d” inverted.

In the above example, two embedding images are embedded in the color image S1. However, the number of embedding images is not limited to this. That is, three or more embedding images can be embedded in the color image S1. In this case, embedding patterns corresponding to the three or more embedding images can be generated and these embedding patterns can be superimposed on the color image.

In the above example, plural embedding patterns are superimposed on the same area in the color image. However, the superimposing area is not limited to this. That is, embedding patterns can be superimposed on different image areas in the color image. For example, the embedding pattern C1 shown in FIG. 3 can be superimposed on a first image area in the color image. Then, the embedding pattern C2 shown in FIG. 4 can be superimposed on a second image area located at a different position from the first image area in the color image.

The combined image S2 generated by the superimposing section 102 is outputted from an output section 106 (see FIG. 1). The combined image S2 outputted from the output section 106 is recorded on a recording object. For example, the combined image S2 can be printed on a sheet.

The combined image S2 generated by the superimposing section 102 is expressed by R, G and B color components. Therefore, when printing the combined image S2, it is preferable to convert the R, G and B color components to C (cyan), M (magenta) and Y (yellow) color components in advance.

Next, general processing (program process) to generate a combined image S2 from a color image S1 will be described with reference to FIG. 5. The processing shown in FIG. 5 can be executed in accordance with a program that is recordable to a recording medium.

The recording medium can be, for example, an internal storage device installed in a computer such as ROM or RAM, a portable storage medium such as CD-ROM, flexible disk, DVD disk, magneto-optical disk or IC card, a database that holds computer programs, or a transmission medium on a line.

A color image S1(x,y) is inputted to the input section 101 (ACT 201). An embedding image Bn(x,y) to be embedded into the color image S1(x,y) and the number of embedding images n are set (ACT 202). For example, the number n and embedding image(s) Bn(x,y) can be set by a user's manual input.

The embedding pattern generating section 104 sets n0 to 1 (ACT 203). The embedding pattern generating section 104 generates a basic pattern An(x,y) (ACT 204). Specifically, the embedding pattern generating section 104 acquires the basic pattern An(x,y) from the memory or receives input of anew basic pattern An(x,y).

The embedding pattern generating section 104 determines whether the embedding image Bn(x,y) has a value of 0 or not (ACT 205). Here, since embedding images are binary images as described above, the embedding image Bn(x,y) shows a value of 0 or 1.

If the embedding image Bn(x,y) has a value of 1, the embedding pattern generating section 104 modulates the basic pattern An(x,y) (ACT 206). In other words, the pixels of the basic pattern are inverted as described with reference to FIG. 3 and FIG. 4.

On the other hand, if the embedding image Bn(x,y) has a value of 0, the embedding pattern generating section 104 does not modulate the basic pattern An(x,y). In other words, the pixels of the basic pattern are not inverted as described with reference to FIG. 3 and FIG. 4.

The superimposing section 102 superimposes the modulated basic pattern An′(x,y) on the color image S1(x,y) and thus generates a combined image S2(x,y) (ACT 207). Then, it is determined whether n0 is n or not (ACT 208). If n0 is not n, 1 is added to n0 (ACT 209). Then, the processing of ACT 204 to ACT 207 is repeated. Meanwhile, if n0 is n, the combined image S2(x,y) is outputted (ACT 210).

Next, a method for reproducing plural embedding images from the combined image S2 will be described. In the following description, a method for reproducing the embedding images B1 and B2 from the combined image S2 formed by superimposing the embedding patterns C1 and C2 (see FIG. 3 and FIG. 4) on the color image S1 will be explained.

The embedding images B1 and B2 are reproduced as a mask sheet (sheet member), described hereinafter, is superimposed on the recording object on which the combined image S2 is recorded.

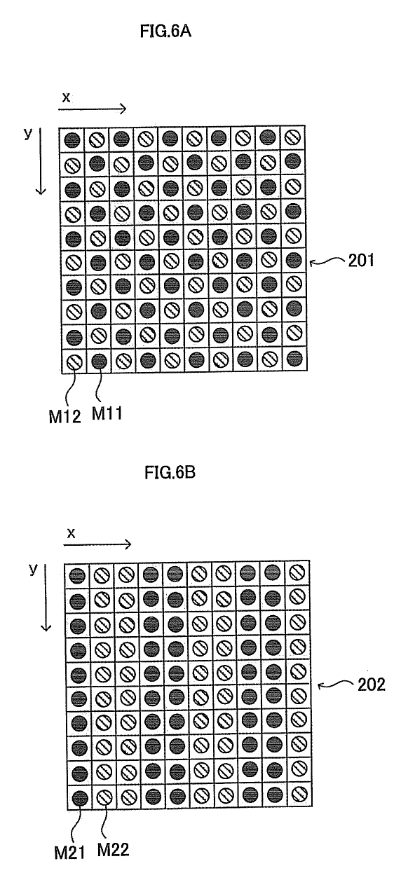

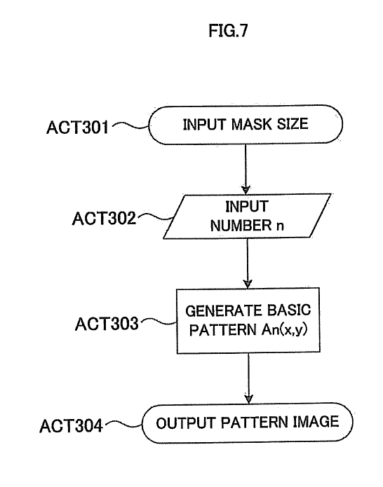

FIG. 6A shows a mask sheet 201 used to reproduce the embedding image B1. The mask sheet 201 has the same pattern as the basic pattern A1 shown in FIG. 3. Pixels M11 are light-shielding areas. Pixels M12 are light-transmitting areas. The pixels M11 have a lower transmittance than the pixels M12.

The mask sheet 201 can be formed, for example, by printing black color at the parts of a transparent sheet that correspond to the pixels M11. The parts that correspond to the pixels M12 remain transparent. Alternatively, the pixels M12 can be black areas and the pixels M11 can be transparent areas.

FIG. 6B shows a mask sheet 202 used to reproduce the embedding image B2. The mask sheet 202 has the same pattern as the basic pattern A2 shown in FIG. 4. Pixels M21 are light-shielding areas. Pixels M22 are light-transmitting areas. The pixels M21 have a lower transmittance than the pixels M22. The mask sheet 202 can be produced similarly to the above mask sheet 201.

FIG. 7 shows processing at the time of printing the pattern of a mask sheet. The processing shown in FIG. 7 can be executed in accordance with a program that is recordable to a recording medium.

The size of the mask sheet is inputted (ACT 301). The number n allocated to the basic pattern is inputted (ACT 302). The size of the mask sheet and the number n can be inputted, for example, by a user.

A basic pattern An(x,y) corresponding to the inputted number n is generated (ACT 303). Specifically, the basic pattern An(x,y) stored in the memory is acquired, or input of a new basic pattern An(x,y) is received.

The basic pattern An(x,y) is outputted and the pattern is printed (ACT 304). The above processing is similar to general image forming processing.

As the mask sheet 201 is superimposed on the recording object on which the combined image is recorded, the embedding image B1 can be observed.

If the mask sheet 201 is superimposed on the combined image, a part of the combined image can be visually recognized only through the light-transmitting areas (pixels M12) of the mask sheet 201. As described above, in the embedding pattern C1 superimposed on the color image S1, a part of the pixels in the basic pattern A1 is inverted by the embedding image B1.

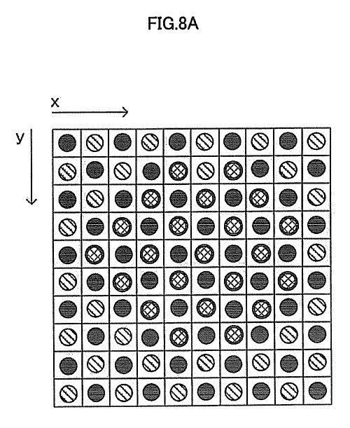

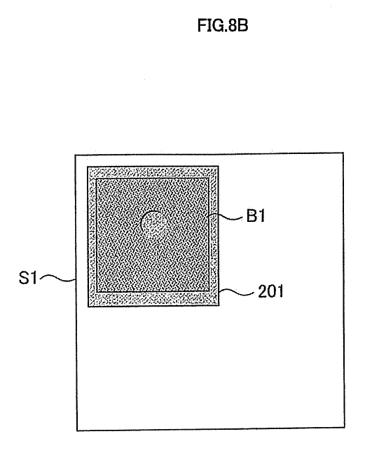

Therefore, if the mask sheet 201 having the same pattern as the basic pattern A1 is used, the inverted pixels are highlighted as shown in FIG. 8A. Therefore, the embedding image B1 can be confirmed from the combined image S2, as shown in FIG. 8B. In the example shown in FIG. 8B, the embedding pattern C1 shown in FIG. 3 is superimposed on a partial area in the color image S1.

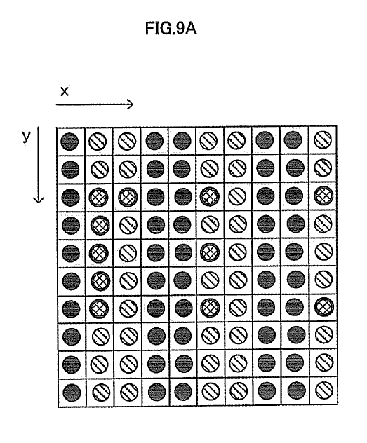

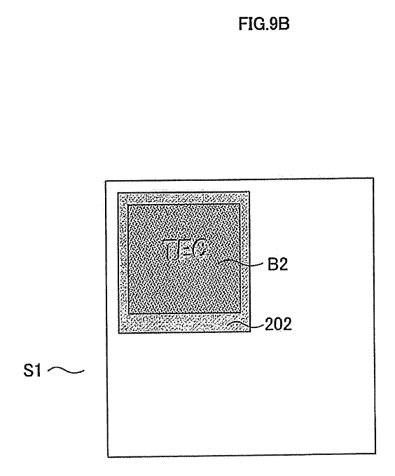

Meanwhile, if the mask sheet 202 is superimposed on the combined image, the embedding image B2 can be observed according to the principle similar to that of the mask sheet 202. Specifically, the pixels inverted from the pixels in the basic pattern A2 are highlighted, as shown in FIG. 9A. Then, the embedding image B2 can be confirmed from the combined image S2, as shown in FIG. 9B. In the example shown in FIG. 9B, the embedding pattern C2 shown in FIG. 4 is superimposed on a partial area in the color image S1.

In the examples shown in FIG. 6A and FIG. 6B, the single basic pattern A1 or A2 is formed for each of the mask sheets 201 and 202. However, the basic patterns are not limited to this. For example, plural basic patterns that are different from each other can be formed in plural areas that are different from each other in one mask sheet. In this case, embedding images can be observed by using the area in which each basic pattern is formed.

Alternatively, a lenticular lens (sheet member) as an optical device can be used instead of the mask sheet. In a lenticular lens, plural cylindrical lens parts are arrayed in parallel. If a lenticular lens is used, the striped basic pattern A2 shown in FIG. 4 can be used. The pitch of the cylindrical lens parts is equal to the pitch in the x-direction in the basic pattern A2.

If the lenticular lens is superimposed on the combined image S2 while matching the pitch of the lenticular lens with the pitch of the basic pattern A2, the embedding image can be confirmed.

In this embodiment, by embedding plural embedding images into a color image, it is possible to enhance the level of security against counterfeit.

Specifically, plural embedding images cannot be confirmed without using plural kinds of mask sheets. After the plural embedding images are confirmed, authenticity of the color image can be determined. Moreover, if plural embedding images are embedded in the same area in the color image S1, each embedding image becomes harder for a third party to discover.

Here, as the number of embedding patterns superimposed on the color image S1 is increased, the level of security against counterfeit can be raised. Meanwhile, repeated superimposition of embedding patterns may cause deterioration in image quality of the combined image S2. The number of embedding patterns superimposed on the color image, that is, the number of embedding images, can be decided in consideration of this point.

### Second Embodiment

In a second embodiment of the invention, plural embedding images are reproduced from a combined image by using one mask sheet. The same parts as described in the first embodiment are denoted by the same reference numerals.

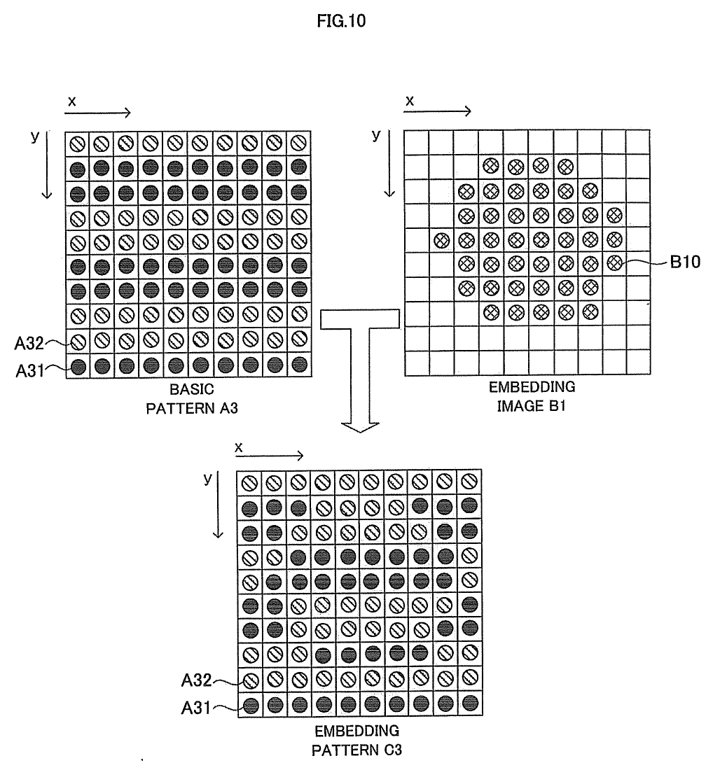

In this embodiment, a basic pattern A3 shown in FIG. 10 is processed (modulated) with the embedding image B1 described with reference to FIG. 3 and an embedding pattern C3 is thus generated.

The basic pattern A3 is a pattern formed by rotating the basic pattern A2 described with reference to FIG. 4 by 90 degrees counterclockwise. Specifically, pixels A31 and A32 are arrayed in the x-direction. The lines of pixels A31 and A32 are arrayed in the y-direction.

The embedding pattern generating section 104 inverts the pixels A31 and A32 in the basic pattern A3 that correspond to the pixels B10 in the embedding image B1 and thereby generates the embedding pattern C3, as described in the first embodiment.

The superimposing section 102 superimposes the embedding pattern C3 shown in FIG. 10 and the embedding pattern C2 shown in FIG. 4 on the color image S1. Thus, a combined image S2 including the embedding images B1 and B2 embedded in the color image S is generated.

If the mask sheet 202 shown in FIG. 6B is superimposed on the combined image S2, the embedding images B1 and B2 can be visually recognized. Specifically, if the mask sheet 202 is arranged such that the pattern of the mask sheet 202 is matched with the basic pattern A3, the embedding image Bi can be visually recognized. Moreover, if the mask sheet 202 is arranged such that the pattern of the mask sheet 202 is matched with the basic pattern A2, the embedding image B2 can be visually recognized.

The basic pattern A3 is a pattern formed by rotating the basic pattern A2 by 90 degrees counterclockwise. However, the pattern is not limited to this. That is, it suffices that the basic pattern A2 exists in any arbitrary direction within a two-dimensional plane. Here, the two basic patterns have point symmetry.

For example, as the basic pattern A3, a pattern formed by rotating the basic pattern A2 by 90 degrees clockwise can be used. Moreover, a pattern formed by rotating the basic pattern A2 by 45 degrees clockwise or counterclockwise can be used as well. In this case, if the mask sheet 202 is rotated within the two-dimensional plane, plural embedding images can be visually recognized in accordance with the rotation angle.

It is also possible to visually recognize plural embedding images by reversing the mask sheet. In other words, a mask sheet with line symmetry about an axis in the x-direction or y-direction can be used. Depending on the pattern of the mask sheet, different patterns can be seen from a specific direction as the mask sheet is reversed.

Therefore, if the mask sheet is arranged with its one side facing the combined image, one embedding image can be visually recognized. Then, if the mask sheet is arranged with its one side facing the observer, the other embedding image can be visually recognized.

In this embodiment, the mask sheet 202 described with reference to FIG. 6B is used, but the mask sheet is not limited to this. For example, the mask sheet 201 described with reference to FIG. 6A can be used as well.

### Third Embodiment

A third embodiment of the invention will be described. In this embodiment, two embedding patterns generated from similar basic patterns to each other are superimposed on a color image, and a combined image is thus generated. The same parts described as in the first embodiment are denoted by the same reference numerals.

If two basic patterns are similar to each other and two embedding patterns generated from these basic patterns are superimposed on the same area in a color image, it is difficult to visually recognize each embedding image by using a mask sheet. Whether basic patterns are similar to each other or not can be determined in accordance with whether embedding images are hard to visually recognize or not, as described above.

In this embodiment, two embedding patterns generated from two similar basic patterns to each other are superimposed on image areas located at different positions from each other within a color image. In other words, plural embedding patterns generated from similar basic patterns to each other are prohibited from being superimposed on the same area in a color image. Thus, two embedding images can easily be visually recognized with the use of a mask sheet. Hereinafter, this is described more specifically.

The embedding pattern generating section 104 acquires first and second basic patterns 105-1 and 105-2 that are similar to each other from the memory 105. Information about whether the basic patterns are similar to each other or not can be stored in the memory 105 in association with the basic patterns.

The embedding pattern generating section 104 processes (modulates) the first and second basic patterns 105-1 and 105-2 on the basis of embedding images 103-1 and 103-2 corresponding to each basic pattern and thereby generates first and second embedding patterns. The embedding pattern generating section 104 supplies information showing that the basic patterns are similar to each other, together with the generated first and second embedding patterns, to the superimposing section 102.

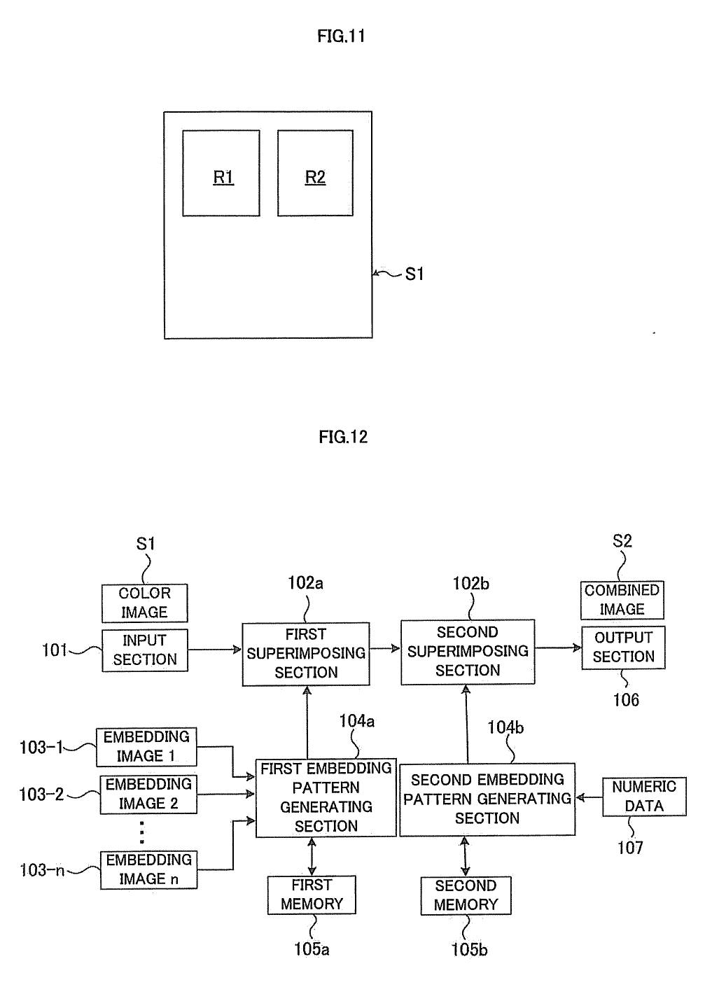

The superimposing section 102 superimposes the first embedding pattern on a first image area R1 in the color image S1 (see FIG. 11). The superimposing section 102 also superimposes the second embedding pattern on a second image area R2 in the color image S1 (see FIG. 11). The positions of the image areas R1 and R2 can be suitably set.

Here, a third embedding pattern can also be superimposed on the image areas R1 and R2. The third embedding pattern is formed by processing (modulating) a third basic pattern that is not similar to the first and second basic patterns, with an embedding image.

If three or more basic patterns are similar to each other, embedding patterns generated from these basic patterns can be superimposed on different image areas from each other in the color image.

In this embodiment, similar basic patterns are specified in advance. However, the basic patterns are not limited to this. For example, the embedding pattern generating section 104 or the superimposing section 102 can determine whether the basic patterns are similar or not, according to a predetermined standard.

### Fourth Embodiment

An image generating apparatus as a fourth embodiment of the invention will be described. In this embodiment, plural embedding images to be observed by using a mask sheet are embedded in a color image, and numeric data (additional information) acquired by image analysis is also embedded in the color image.

The configuration of the image generating apparatus according to the present embodiment will be described with reference to FIG. 12. In FIG. 12, the same components as those described with reference to FIG. 1 are denoted by the same reference numerals.

A first embedding pattern generating section 104a processes a basic pattern in accordance with an embedding image and thereby generates an embedding pattern. A first memory 105a stores plural basic patterns corresponding to plural embedding images. A first superimposing section 102a superimposes the plural embedding patterns generated by the first embedding pattern generating section 104a on the color image S1. The operations of the first embedding pattern generating section 104a and the first superimposing section 102a are the same as described in the first embodiment.

Hereinafter, a method for embedding numeric data in a color image will be described. It is confirmed that the human gradation identifying ability of human beings is high with respect to changes in the luminance direction and low with respect to changes in the color difference direction. Thus, as in the first embodiment, numeric data can be embedded by utilizing this characteristic. In color images, generally, color difference components do not contain high-frequency components.

The color image (combined image) generated by the first superimposing section 102a is inputted to a second superimposing section 102b. The operation of the first superimposing section 102a and the operation of the second superimposing section 102b can be carried out by one component (superimposing section).

Numeric data 107 is supplied to a second embedding pattern generating section (generating section) 104b. The numeric data 107 is supplied to the second embedding pattern generating section 104b as a code including plural bits.

The second embedding pattern generating section 104b generates a pattern (embedding pattern) having plural frequency components based on the inputted numeric data 107. In this embodiment, the second embedding pattern generating section 104b generates a pattern having plural frequency components by using basic patterns stored in a second memory 105b.

The plural basic patterns stored in the first memory 105a may be the same as or different from the plural basic patterns stored in the second memory 105b. Also, a pattern can be newly generated on the basis of plural frequency components that are set on the basis of the numeric data 107.

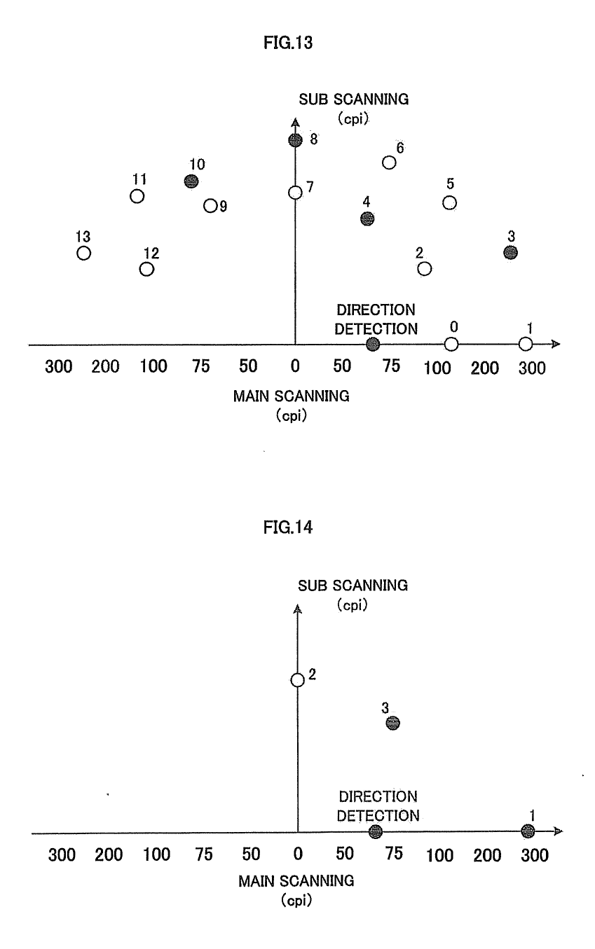

The processing by the second embedding pattern generating section 104b will be described with reference to FIG. 13.

FIG. 13 shows a Fourier transform plane formed by an axis in the main scanning direction and an axis in the sub scanning direction. Plural points are arranged on the Fourier transform plane. Each point corresponds to each bit forming the code and has a cycle and amplitude. On the Fourier transform plane, the distance of a point from the origin represents its cycle. The closer to the origin the point is, the longer its cycle is. The farther the point is away from the origin, the shorter its cycle is.

The example shown in FIG. 13 is set in such a manner that a code including 13 bits can be used.

Solid black circles shown in FIG. 13 indicate that these bits are set to be ON. A bit that is set to be ON indicates that the frequency component of this bit is added to the color image. White circles shown in FIG. 13 indicate that these bits are set to be OFF. A bit that is set to be OFF indicates that the frequency component of this bit is not added to the color image.

In the example shown in FIG. 13, bits 3, 4, 8 and 10 are ON. In decimal notation, this is expressed as “1304”. This value serves as the numeric data 107. At the time of embedding this numeric data in the color image, the second embedding pattern generating section 104b generates a pattern having plural frequency components corresponding to the bits 3, 4, 8 and 10.

Here, a point for direction detection is set on the Fourier transform plane. This point is used to align the direction of the image at the time of reading the numeric data (code) embedded in the color image with the direction of the image at the time of embedding the numeric data. The point for direction detection is constantly set to be ON when embedding the numeric data 107.

It is preferable that the point for detection direction has an angle that does not easily cause deterioration and has a low frequency component so that the direction of the image can easily be detected. It is also preferable that a frequency component that is different from the frequency component of the point for direction detection is used as the frequency component of each bit forming the numeric data (code). This enables prevention of erroneous direction detection.

The second embedding pattern generating section 104b supplies the embedding pattern having plural frequency components to the second superimposing section 102b. The second superimposing section 102b superimposes the embedding pattern from the second embedding pattern generating section 104b on the color image and thus generates the combined image S2. Then, the output section 106 outputs the combined image S2. The combined image S2 is recorded on a recording object as described in the first embodiment.

Next, a method for reproducing information embedded in the color image S1 will be described.

The embedding image embedded in the color image S1 can be reproduced as a mask sheet is superimposed on the combined image, as in the first embodiment.

Meanwhile, the numeric data embedded in the color image is reproduced as follows.

First, the color image (combined image) in which the numeric data is embedded is scanned by a scanner or the like and image data is thus generated. Specifically, the image area in which the numeric data is embedded, in the color image, is scanned. The scanned image data is then Fourier-transformed.

Next, a frequency component for angle detection is detected on the Fourier transform plane and the angle of the scanned image is adjusted on the basis of the result of the detection. Whether a frequency component exists at each bit or not is confirmed in order of bit number. “1” is set if there is a frequency component. “0” is set if there is no frequency component. Thus, the numeric data 107 can be reproduced.

Here, the numeric data 107 embedded in the color image 107 can be associated with the embedding image. The association in this case means that the numeric data 107 can specify the embedding image.

By embedding the numeric data 107 thus associated with the embedding image into the color image S1, it is possible to construct a system with a high security level. For example, if a counterfeited embedding image is embedded in the color image, the numeric data can be scanned and it can thus be confirmed whether the embedding image that is visually recognized by using a mask sheet is authentic or not.

### Fifth Embodiment

In a fifth embodiment of the invention, plural embedding images are embedded in a color image and information (additional information) indicating truth or falsehood of the embedding image is also embedded in the color image. A true embedding image is an image that is truly used by a person who reproduces the embedding image. A false embedding image is an image that has no value of use to a person who reproduces the embedding image.

The information indicating truth or falsehood of the embedding image can be embedded in the color image by a similar method to the embedding method of the numeric data described in the fourth embodiment.

Specifically, as in the fourth embodiment, plural points are provided on the Fourier transform plane and the plural points and plural embedding images are associated with each other by using reference numbers.

For example, three points are provided on the Fourier transform plane, as shown in FIG. 14. The three points correspond to three embedding images to be embedded in the color image. The numbers attached to the points indicate their reference numbers. Also, a point for direction detection is provided on the Fourier transform plane, as in the fourth embodiment.

The second embedding pattern generating section 104b generates an embedding pattern having plural frequency components on the basis of ON or OFF state of each point shown in FIG. 14. For example, a point corresponding to a false embedding image is set to be OFF. A point corresponding to a true embedding image is set to be ON.

The second superimposing section 102b superimposes the embedding pattern from the second embedding pattern generating section 104b on the color image. Thus, the combined image S2 is generated.

Meanwhile, by conducting similar image analysis to the fourth embodiment, it is possible to acquire information embedded in the combined image S2. Specifically, the scanned image data is Fourier-transformed and the presence or absence of a frequency component at each point is detected.

Thus, if a frequency component is confirmed at a point on the Fourier transform plane, the embedding image associated with this point by reference number can be regarded as a true embedding image. If no frequency component is confirmed at a point on the Fourier transform plane, the embedding image associated with this point by reference number can be regarded as a false embedding image.

The invention is described in detail with reference to specific embodiments. However, it is obvious to those skilled in the art that various changes and modifications can be made without departing from the spirit and scope of the invention.

As described above in detail, according to the invention, a technique of superimposing plural additional images on a color image and thus generating a combined image can be provided.

What is claimed is:

1. An image generating apparatus comprising:
a modulating section which, by using different additional images corresponding to different pattern images, modulates signals of the pattern images to generate plural modulated pattern images; and
a superimposing section which, by changing color information of a color image in accordance with each of the modulated pattern images, superimposes the plural modulated pattern images on the color image to generate a recordable combined image.

2. The apparatus according to claim 1, wherein the superimposing section superimposes each of the plural modulated pattern images on each of plural image areas in the color image.

3. The apparatus according to claim 1, wherein the superimposing section superimposes the modulated pattern image generated from a first pattern image on a first image area in the color image and superimposes the modulated pattern image generated from a second pattern image similar to the first pattern image on a second image area that is different from the first image area in the color image.

4. The apparatus according to claim 1, wherein the superimposing section superimposes the plural modulated pattern images on the same area in the color image.

5. The apparatus according to claim 1, wherein the superimposing section changes at least one of color difference and saturation included in the color information.

6. The apparatus according to claim 4, wherein the superimposing section generates a difference in a direction of changing color difference included in the color information in accordance with each of the modulated pattern images when superimposing the plural modulated pattern images on the same area in the color image.

7. The apparatus according to claim 1, wherein the pattern images comprise a pattern image with point symmetry or line symmetry.

8. The apparatus according to claim 1, wherein the combined image is printed on a print object.

9. The apparatus according to claim 1, wherein each of the additional images is visually recognized as a sheet member, which has transmittance distribution corresponding to each of the pattern images, is superimposed on a print object with the combined image printed thereon.

10. The apparatus according to claim 9, wherein the additional images comprise an additional image indicating truly used information to an observer using the sheet member, and an additional image indicating false information to the observer.

11. The apparatus according to claim 1, wherein the superimposing section superimposes a pattern image having plural frequency components corresponding to additional information, together with the modulated pattern image, on the color image.

12. The apparatus according to claim 11, further comprising a generating section which generates the pattern image having the frequency components from the pattern image used to generate the modulated pattern image.

13. The apparatus according to claim 11, wherein the additional information is information that specifies the additional image.

14. The apparatus according to claim 11, wherein the additional information is information that identifies an additional image indicating truly used information and an additional image indicating false information, of the plural additional images.

15. An image generating method comprising:
by using different additional images corresponding to different pattern images, modulating signals of the pattern images to generate plural modulated pattern images; and
by changing color information of a color image in accordance with each of the modulated pattern images, superimposing the modulated pattern images on the color image to generate a recordable combined image.

16. The method according to claim 15, wherein the modulated pattern image is superimposed on the color image by changing at least one of color difference and saturation included in the color information.

17. The method according to claim 15, wherein a difference is generated in a direction of changing color difference included in the color information in accordance with each of the modulated pattern images when superimposing the modulated pattern images on the same area in the color image.

18. A program which causes a computer to execute processing comprising:
by using different additional images corresponding to different pattern images, modulating signals of the pattern images to generate plural modulated pattern images; and
by changing color information of a color image in accordance with each of the modulated pattern images, superimposing the plural modulated pattern images on the color image to generate a recordable combined image.

19. The program according to claim 18, wherein the modulated pattern image is superimposed on the color image by changing at least one of color difference and saturation included in the color information.

20. The program according to claim 18, wherein a difference is generated in a direction of changing color difference included in the color information in accordance with each of the modulated pattern images when superimposing the modulated pattern images on the same area in the color image.
